(19) United States
(12) Patent Application Publication
(10) Pub. No.: US 2026/0132589 A1
(43) Pub. Date: May 14, 2026

(54) Connection device for detachable Backhoe

(71) Applicant: TAESUNG MFG. CO., LTD, Gyeonggi-do (KR)

(72) Inventor: Gye Hee YOU, Gyeonggi-do (KR)

(21) Appl. No.: 19/044,627

(22) Filed: Feb. 4, 2025

(30) Foreign Application Priority Data
Nov. 8, 2024 (KR) 10-2024-0157721

(51) Int. Cl. E02F 3/36

(52) U.S. Cl. CPC E02F 3/3695

(57) ABSTRACT

Proposed is a connection device for a detachable backhoe that allows a backhoe to be easily attached to or detached from a tractor and maintains the stable coupling state of the backhoe to the tractor so that the backhoe does not shake during operation thereof on the tractor. The connection device includes a fixing bracket mounted to the tractor, a rotating plate mounted to the backhoe and having a rotation recess formed on a lower portion thereof inserted into the insertion space, with first, second, and third hinge parts being formed on an upper portion of the rotating plate, first and second locking members installed on a first hinge part and a second hinge part, respectively, and a third locking member that is installed on the third hinge part to rotate in place together with a handle member and fixes the first and second locking members.

### CROSS REFERENCE TO RELATED APPLICATION

The present application claims priority to Korean Patent Application No. 10-2024-157721, filed November 8, 2024, the entire contents of which are incorporated herein for all purposes by this reference.

### BACKGROUND OF THE INVENTION

### FIELD OF THE INVENTION

The present disclosure relates to a connection device for a detachable backhoe that attaches and detaches a backhoe to and from a tractor.

### DESCRIPTION OF THE RELATED ART

Generally, a front loader is mounted on the front of a tractor to perform tasks such as excavating soil, excavating rock, demolishing concrete structures, and loading soil, rocks, etc. into a truck by using a bucket.

Recently, the tractor has been equipped with a front loader at the front for loading operation, and a backhoe at the rear for excavating operation.

That is, recently, a construction machine called a backhoe loader has been developed to perform both loading operation and excavating operation at the front and rear of the tractor.

In this regard, Patent Document 1 provides a backhoe loader which includes a backhoe working part provided on the rear side of a vehicle body and having a backhoe bucket whose position is adjusted as a boom and a dipper are rotated by a hydraulic cylinder.

In addition, currently, a connection device for a detachable backhoe has been needed to attach and detach a backhoe to a tractor.

### Document of Related Art

(Patent Document 1) Korean Patent Application Publication No.10-2023-0036653 (published on March 15, 2023)

### SUMMARY OF THE INVENTION

Accordingly, the present disclosure has been made keeping in mind the above problems occurring in the related art, and the present disclosure is intended to propose a connection device for a detachable backhoe that allows a backhoe to be easily attached to or detached from a tractor, and maintains the stable coupling state of the backhoe to the tractor so that the backhoe does not shake during operation thereof on the tractor.

In order to achieve the objectives of the present disclosure, there is provided a connection device for a detachable backhoe for attaching and detaching a backhoe to and from a tractor, the connection device including: a fixing bracket mounted to the tractor in such a manner that a first plate and a second plate are installed to face each other so that an insertion space is formed between the first and second plates, first coupling holes are formed to face each other in upper portions of the first and second plates, respectively, second coupling holes are formed to face each

other in lower portions of the first and second plates, respectively, an upper pin is coupled to the first coupling holes, and a lower pin is coupled to the second coupling holes; a rotating plate mounted to the backhoe and having a rotation recess formed on a lower portion thereof inserted into the insertion space so that the rotation recess is fitted over the lower pin to rotate about the lower pin, with first, second, and third hinge parts being formed on an upper portion of the rotating plate by protruding there from; first and second locking members installed on a first hinge part and a second hinge part, respectively, so as to rotate in place toward the upper pin while being elastically supported by first and second springs, respectively, wherein the first and second locking members have first and second holding recesses, respectively, formed on surfaces thereof facing each other, and move over upper and lower portions of the upper pin, respectively, when the rotating plate rotates and the upper pin is fitted into the first and second holding recesses so that the first and second locking members are fixed by being held by the upper pin; and a third locking member that is installed on the third hinge part to rotate in place together with a handle member and fixes the first and second locking members so that the first and second locking members are prevented from being rotated further when the first and second locking members are rotated by the handle member with the first and second locking members fixed to the upper pin.

According to the present disclosure, when the rotation recess of the rotating plate mounted on the backhoe is rotated about the lower pin of the fixing bracket mounted on the tractor, the first and second locking members move over the upper and lower portions of the upper pin of the fixing bracket by the elasticity of the first and second springs, respectively, thereby allowing the first and second holding recesses of the first and second locking members to be held on or released from the upper pin of the fixing bracket.

For this reason, the connection device for a detachable backhoe of the present disclosure allows the backhoe to be easily attached to and detached from the tractor.

According to the present disclosure, while the first and second locking members are fixed to the upper pin of the fixing bracket, the third locking member, which is rotated by the handle member, prevents further rotation thereof.

In addition, the first holding surface of a first locking member is in contact with and held by a second holding surface of the third locking member, thereby preventing further rotation of the first locking member.

In addition, a third holding recess of a second locking member is held by a first holding part of the third locking member, which is fitted into the third holding recess, thereby preventing further rotation of the second locking member.

For this reason, the locking states of the first and second locking members are maintained by the third locking member, thereby maintaining the stable coupling state of the backhoe so that the backhoe does not shake during operation thereof on the tractor.

According to the present disclosure, between the first, second, and third locking members, a second holding part by which the first, second, and third locking members are held is formed on the rotating plate, thereby preventing excessive rotations of the first, second, and third locking members by using one second holding part formed on the rotating plate.

For this reason, during attachment/detachment operation of the backhoe, the first, second, and third locking members is prevented from being in contact with each other due to excessive rotation thereof by using one second holding part.

According to the present disclosure, a first support plate supporting a first hook of a first spring is prevented from being detached from a first fixing part by a first fixing pin.

In addition, a second support plate supporting the first hook of the second spring is prevented from being detached from a second fixing part by a second fixing pin.

In addition, second hooks of the first and second springs are positioned between the three first nuts fastened to a first bolt, thereby being fitted into and engaged with the screw grooves of the first bolt.

For this reason, the first and second springs are prevented from being moved from their original positions thereof.

According to the present disclosure, when the fastening of the first bolt and the first nuts is released and the first and second fixing pins are removed from first and third through holes of the first and second fixing parts, it is possible to separate the first and second springs.

For this reason, it is possible to replace the first and second springs that have lost elasticity thereof.

According to the present disclosure, third and fourth support plates support opposite sides of the first, second, and third locking members, thereby helping the stable rotations of the first, second, and third locking members and preventing detachment thereof.

According to the present disclosure, when the fastening of the second and third bolts and second and third nuts is released, it is possible to remove the first and second locking members.

For this reason, it is possible to replace the first and second locking members that are damaged by friction caused by frequent rotations thereof.

According to the present disclosure, when a third fixing pin is removed from a sixteenth through hole of a rotating rod, it is possible to remove the third locking member.

For this reason, it is possible to replace the third locking member that has been damaged by friction caused by frequent rotations thereof.

In addition, it is possible to detach a third spring, thereby enabling the replacement of the third spring that has lost elasticity thereof.

According to the present disclosure, a fitting part of the handle member is fitted through a twelfth through hole of the third locking member into a first fixing hole of the rotating plate, thereby preventing rotation of the third locking member.

For this reason, there is an effect of further maintaining the locking state of the third locking member by using the handle member.

According to the present disclosure, a fitting rod of the handle member is fitted through an eighteenth through hole of the first locking member into a second fixing hole of the rotating plate, thereby preventing the rotation of the first locking member.

For this reason, there is an effect of further maintaining the locking state of the first locking member by using the handle member.

According to the present disclosure, the rigidity of the first and second coupling holes of the fixing bracket is increased by first and second reinforcement parts, thereby preventing the first and second coupling holes of the fixing bracket from being damaged by pressure caused by long-term use and load.

According to the present disclosure, the rigidity of the rotation recess of the rotating plate is increased by a third reinforcement part, thereby preventing the rotation recess of the rotating plate from being damaged by pressure caused by long-term use and load.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view illustrating the installation state of a connection device for a detachable backhoe according to an embodiment of the present disclosure.

FIGS. 2 to 4 are the front view, plan view, and left side view of the connection device for a detachable backhoe according to the embodiment of the present disclosure.

FIGS. 5 to 10 are exploded perspective views of the connection device for a detachable backhoe according to the embodiment of the present disclosure.

FIGS. 11 to 13 are a perspective view and front views illustrating a portion of the connection device for a detachable backhoe according to the embodiment of the present disclosure.

FIGS. 14 to 24 are partially enlarged views and detailed views of the connection device for a detachable backhoe according to the embodiment of the present disclosure; and

FIGS. 25 to 34 are views illustrating the state of the use of the connection device for a detachable backhoe according to the embodiment of the present disclosure.

### DETAILED DESCRIPTION OF THE INVENTION

An embodiment of the present disclosure may be modified in many different forms, and the scope of the present disclosure should not be construed as being limited to the embodiment detailed below. This embodiment is provided to more safely explain the present disclosure to a person of average knowledge in the art. Accordingly, the shapes of elements in the drawings may be exaggerated to emphasize a clearer explanation.

Accordingly, the embodiment of the present disclosure as described above will be described in detail on the basis of the attached drawings as follows.

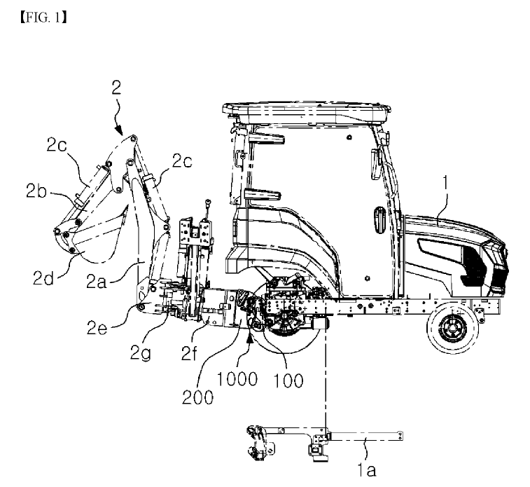

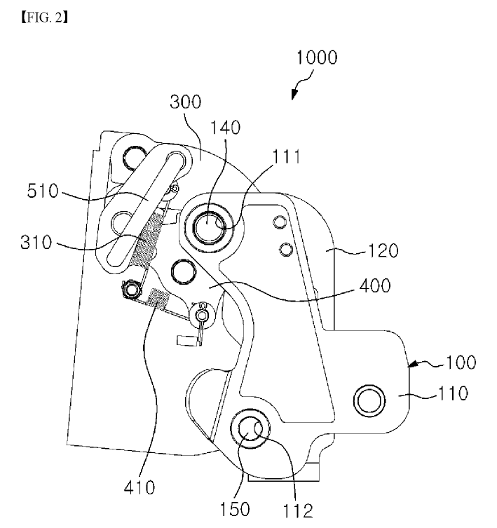

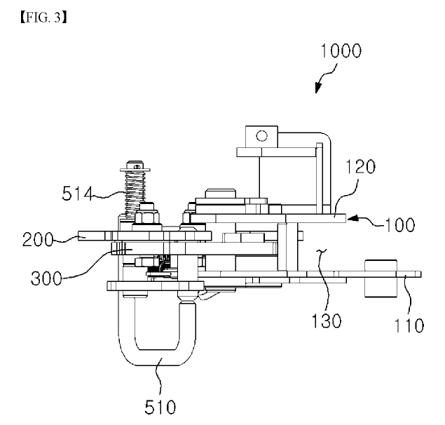

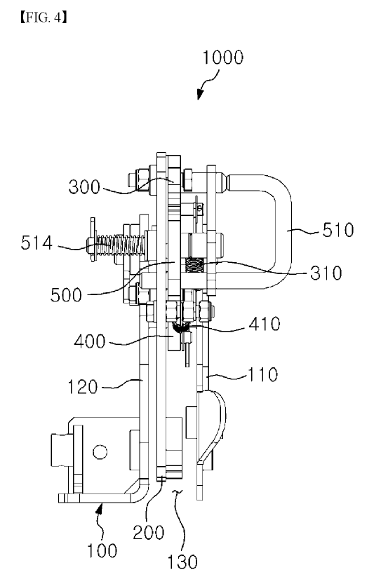

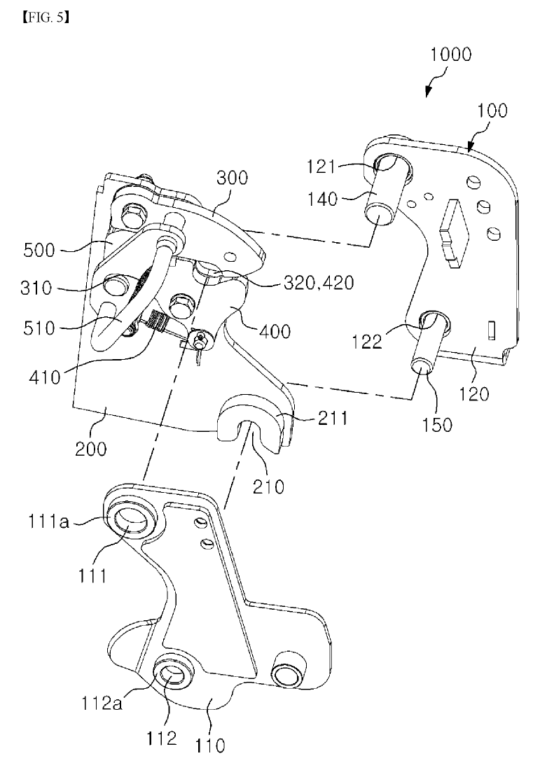

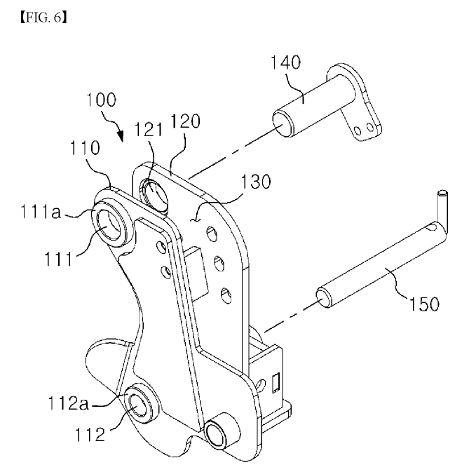

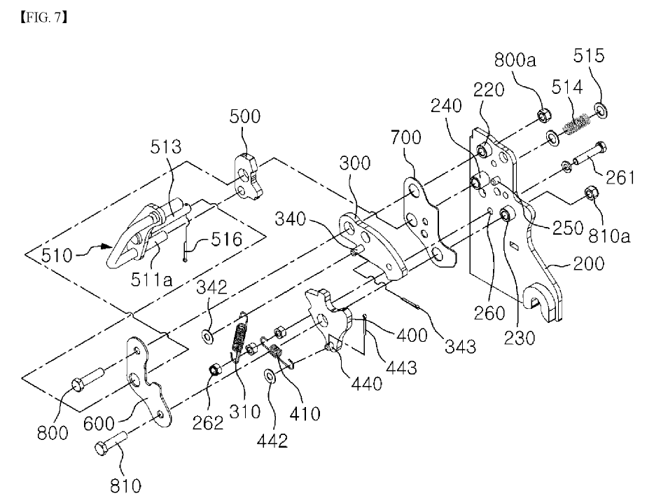

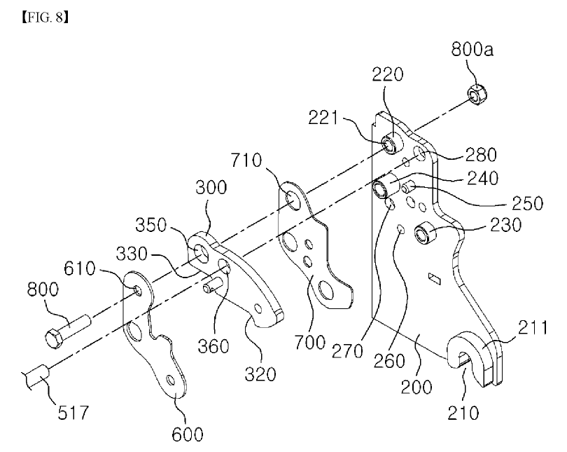

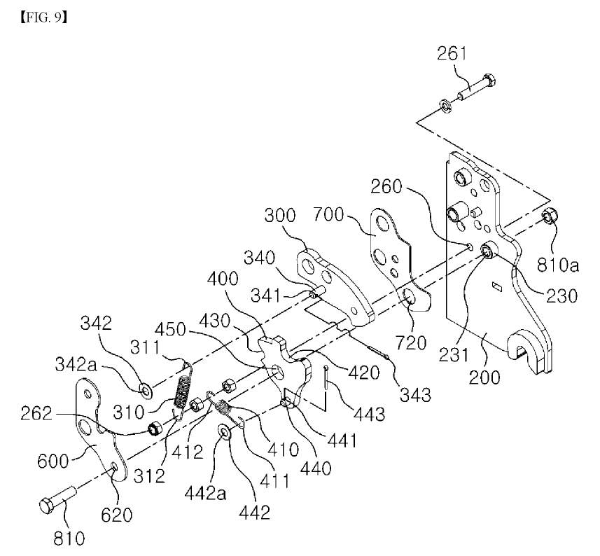

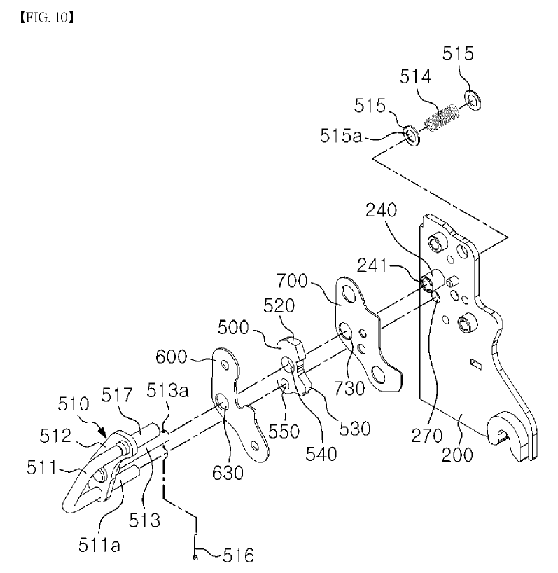

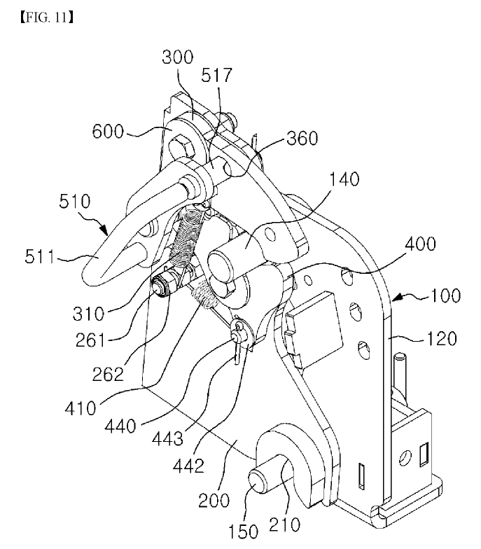

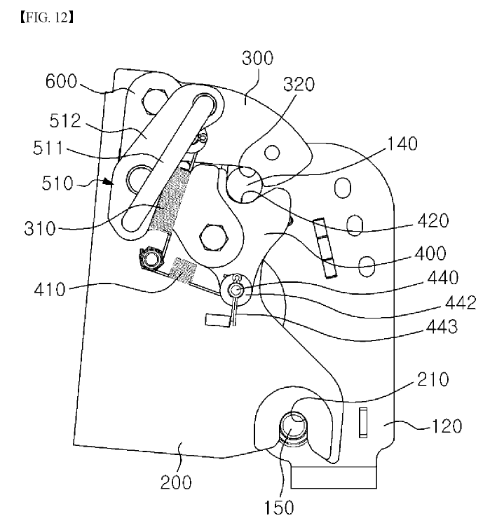

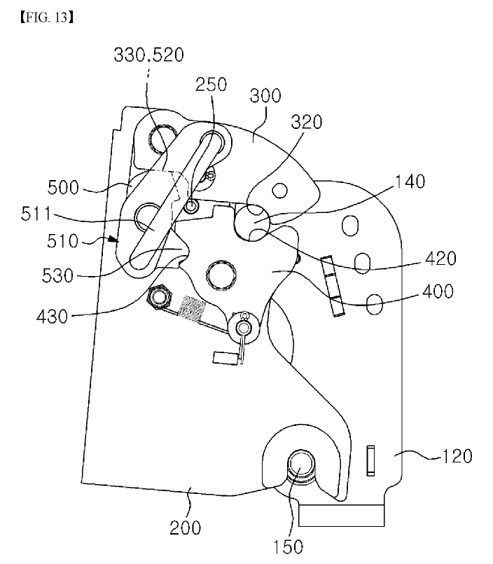

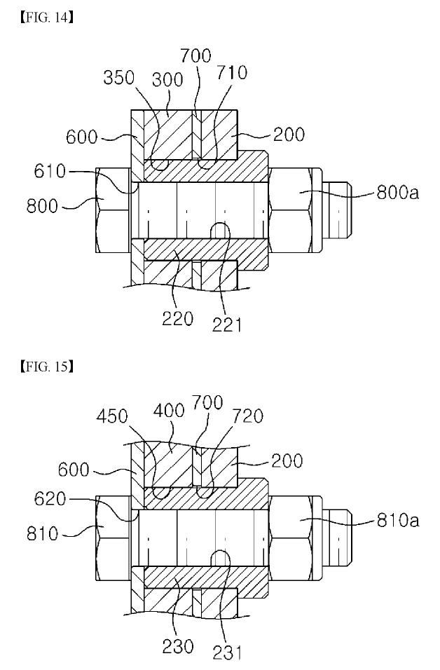

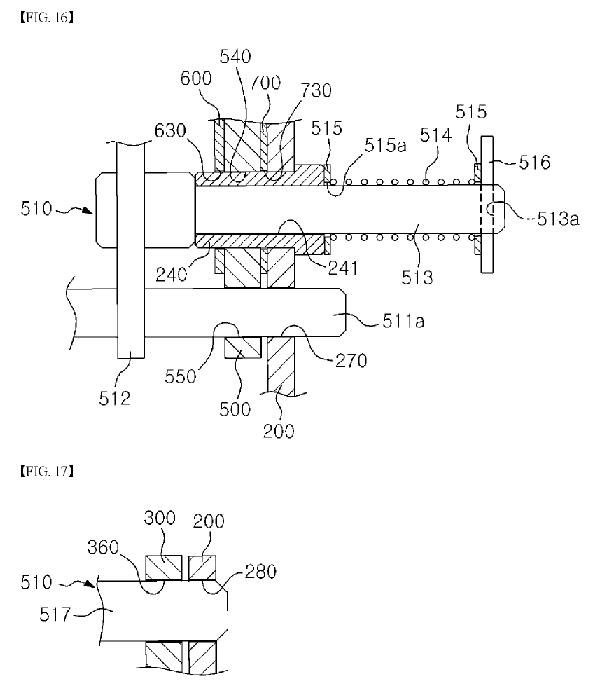

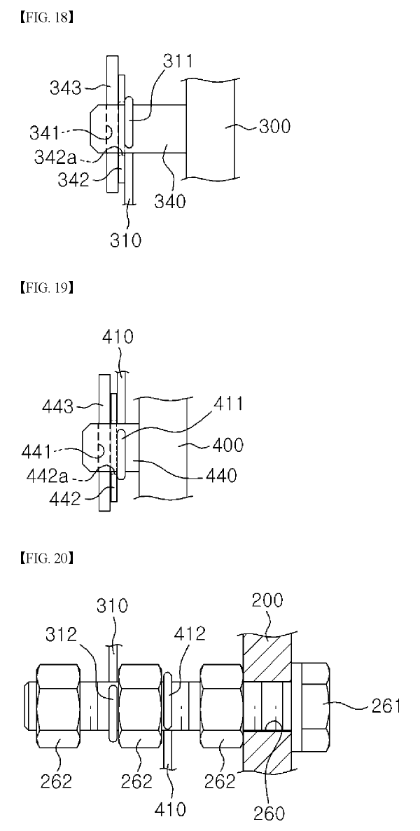

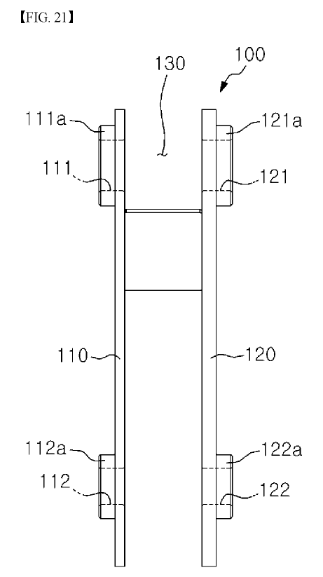

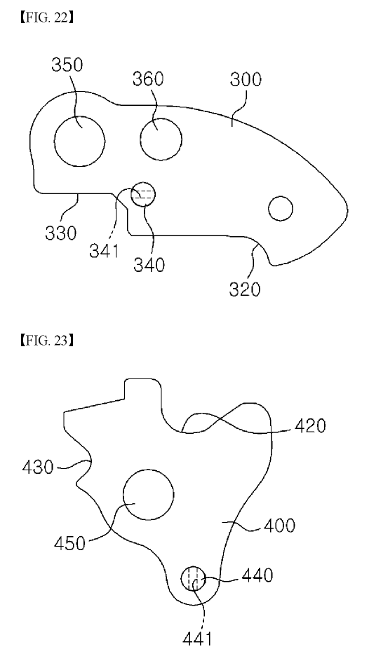

As illustrated in FIGS. 1 to 34, a connection device 1000 for a detachable backhoe according to the embodiment of the present disclosure is used when attaching or detaching a backhoe 2 to or from the rear of the tractor 1.

Here, the connection device 1000 for a detachable backhoe is installed between the rear of the tractor 1 and the backhoe 2.

In addition, although not shown in the drawing, the front of the above tractor 1 may be equipped with a front loader capable of loading soil, rocks, etc. into a truck by using a bucket.

The backhoe 2 includes a bucket 2d whose position is adjusted as a boom 2a and a dipper 2b are rotated by a cylinder 2c, a body 2e on which the boom 2a is rotatably installed, a connection frame 2f connected to the rear of the tractor 1 by the connection device 1000 for a detachable backhoe, and a rotating member 2g that is located on the connection frame 2f to rotate the body 2e.

Here, the backhoe 2 may include a device that performs a different task from the bucket 2d instead of the bucket 2d.

The connection device 1000 for a detachable backhoe includes a fixing bracket 100 mounted to the tractor 1 such a manner that the first plate 110 and the second plate 120 are installed to face each other so that an insertion space 130 is formed between first and second plates 110 and 120, first coupling holes 111 and 121 are formed to face each other in upper portions of the first and second plates 110 and 120, respectively, second coupling holes 112 and 122 are formed to face each other in lower portions of the first and second plates 110 and 120, respectively, an upper pin 140 is coupled to the first coupling holes 111 and 121, and a lower pin 150 is coupled to the second coupling holes 112 and 122the tractor 1.

Here, the fixing bracket 100 is mounted to an attachment frame 1a mounted to the tractor 1 and is mounted to the rear of the tractor 1 by the attachment frame 1a.

In addition, around the first coupling holes 111 and 121, first reinforcement parts 111a and 121a are formed on the outer surfaces of the first and second plates 110 and 120, respectively, by protruding therefrom.

Here, the rigidity of the first coupling holes 111 and 121 is increased by the first reinforcement parts 111a and 121a.

In addition, around the second coupling holes 112 and 122, second reinforcement parts 112a and 122a are formed to protrude from the outer surfaces of the first and second plates 110 and 120, respectively.

Here, the rigidity of the second coupling holes 112 and 122 is increased by the second reinforcement parts 112a and 122a.

The connection device 1000 for a detachable backhoe includes a rotating plate 200 mounted to the backhoe 2 and having a rotation recess 210 formed on a lower portion thereof inserted into the insertion space 130 so that the rotation recess 210 is fitted over the lower pin 150 to rotate about the lower pin 150, with first, second, and third hinge parts220, 230, and 240being formed on an upper portion of the rotating plate 200 by protruding therefrom.

Here, the rotating plate 200 is mounted to the connection frame 2f of the backhoe 2.

In addition, the first hinge part 220 is formed to protrude from the opposite surfaces of the rotating plate 200 at the upper portion of the rotating plate 200, that is, from the front and rear surfaces thereof, a second hinge part 230 is formed to protrude from the opposite surfaces of the rotating plate 200 at the upper portion of the rotating plate 200, that is, from the front and the rear surfaces thereof so that the second hinge part 230 is positioned lower than the first hinge part 220, and the third hinge part 240 is formed to protrude from the opposite surfaces of the rotating plate 200 at the upper portion of the rotating plate 200 when viewed from the front, that is, from the front and rear surfaces thereof so that the third hinge part 240 is positioned between the first and second hinge parts 220 and 230.

In addition, around the rotation recess 210, a third reinforcement part 211 is formed to protrude from the outer surface of the rotating plate 200.

Here, the rigidity of the rotation recess 210 is increased by the third reinforcement part 211.

The connection device 1000 for a detachable backhoe includes first and second locking members 300 and 400 installed on the first hinge part 220 and the second hinge part 230, respectively, so as to rotate in place toward the upper pin 140while being elastically supported by first and second springs 310 and 410, respectively, wherein the first and second locking members 300 and 400 have first and second holding recesses 320 and 420, respectively, formed on surfaces thereof facing each other, and move over upper and lower portions of the upper pin 140, respectively, when the rotating plate 200 rotates and the upper pin 140 is fitted into the first and second holding recesses 320 and 420so that the first and second locking members 300 and 400 are fixed by being held by the upper pin 140.

Here, the first holding recess 320 is formed on the lower surface of a first locking member 300 when viewed from the front, and the second holding recess 420 is formed on the upper surface of the second locking member 400 when viewed from the front.

The connection device 1000 for a detachable backhoe includes a third locking member 500that is installed on the third hinge part 240 to rotate in place together with a handle member 510 and fixes the first and second locking members 300 and 400so that the first and second locking members 300 and 400 are prevented from being rotated further when the first and second locking members 300 and 400 are rotated by the handle member 510with the first and second locking members 300 and 400fixed to the upper pin 140.

The first holding surface 330 is formed on the surface of the first locking member 300 adjacent to the third locking member 500.

Here, the first holding surface 330 is formed on the lower surface of the first locking member 300 opposite to the first holding recess 320 when viewed from the front.

A second holding surface 520 is formed on a surface of the third locking member 500adjacent to the first locking member 300, so that the second holding surface 520 is in contact with the first holding surface 330when the third locking member 500 is rotated by the handle member 510 and fixes the first locking member 300so that the first locking member 300 is prevented from being rotated further.

Here, the second holding surface 520 is formed on the upper surface of the third locking member 500 when viewed from the front.

In addition, the first holding surface 330 of the first locking member 300 is in surface contact with the second holding surface 520 of the third locking member 500, and at the same time, the first locking member 300 is prevented from being rotated further.

A third holding recess 430 is formed on a surface of the second locking member 400 adjacent to the third locking member 500.

Here, the third holding recess 430 is formed on the side surface of the second locking member 400 when viewed from the front and is formed in a shape similar to a triangle.

A first holding part 530 is formed to protrude on a surface of the third locking member 500 adjacent to the second locking member 400, so that the first holding part 530 is fitted into and held in the third holding recess 430 when the third locking member 500 is rotated by the handle member 510 and fixes the second locking member 400 so that the second locking member 400 is prevented from being rotated further.

Here, the first holding part 530 is formed to protrude in a triangle-like shape on the side surface of the third locking member 500 when viewed from the front.

A second holding part 250 positioned between the first, second, and third locking members 300, 400, and 500 is formed to protrude on an upper portion of the rotating plate 200.

Here, the first and second locking members 300 and 400 are held by the second holding part 250 when the first and second locking members 300 and 400 are not fixed to the upper pin 140.

That is, the first and second locking members 300 and 400 are rotated by the elasticity of the first and second springs 310 and 410 in normal times or when unlocked from the upper pin 140. In this case, the first and second locking members 300 and 400 are held by the second holding part 250 and are not in contact with each other.

In addition, the third locking member 500 is held by the second holding part 250whenthe first and second locking members 300 and 400 are in a state in which the first and second locking members 300 and 400 are capable of being rotated when the third locking member 500 is rotated by the handle member 510.

That is, when the third locking member 500 is rotated by the handle member 510so that the first and second locking members 300 and 400 are unlocked, the third locking member 500 is held by the second holding part 250 and is not in contact with the second locking member 400.

A first fixing part 340 having a first through hole 341 is formed to protrude on the outer surface of the first locking member 300toward the opposite side of the rotating plate 200.

Here, a first hook 311 formed in the shape of a hook on one side of a first spring 310 is hooked to the first fixing part 340, and the first fixing part 340 is formed on a portion close to the center of the front surface of the first locking member 300 when viewed from the front.

The connection device 1000 for a detachable backhoe includes a first support plate 342 which has a second through hole 342a through which the first fixing part 340 passes and supports the first hook 311; and a first fixing pin 343 which is fitted into the first through hole 341 and prevents the first support plate 342 from being detached from the first fixing part 340.

Here, the first support plate 342 is configured as a washer.

A second fixing part 440 having a third through hole 441 is formed to protrude on the outer surface of the second locking member 400 toward the opposite side of the rotating plate 200.

Here, the first hook 411 formed in a hook shape on one side of the second spring 410 is hooked to the second fixing part 440, and the second fixing part 440 is formed on the lower portion of the front surface of the second locking member 400 when viewed from the front.

The connection device 1000 for a detachable backhoe includes a second support plate 442 which has a fourth through hole 442a through which the second fixing part 440 passes and supports the first hook 411; and a second fixing pin 443 which is fitted into the third through hole 441 and prevents the second support plate 442 from being detached from the second fixing part 440.

Here, the second support plate 442 is configured as a washer.

A fifth through hole 260 is formed on the outer surface of the rotating plate 200.

Here, the fifth through hole 260 is formed through the upper portion of the front surface of the rotating plate 200 when viewed from the front so as to be positioned between the second and third hinge parts 230 and 240.

The connection device 1000 for a detachable backhoe includes a first bolt 261which passes through the fifth through hole 260 so that second hooks 312 and 412 formed in hook shapes on the opposite sides of the first and second springs 310 and 410, respectively, are hooked to a portion of the first bolt 261 passing through the fifth through hole 260; and three first nuts 262 which fix the first bolt 261 to the fifth through hole 260 and are fastened to the first bolt 261 so that the second hooks 312 and 412 are located between the three first nuts 262.

Here, a head part of the first bolt 261 is in close contact with the rotating plate 200, and a first nut 262 closest to the head part of the first bolt 261 is fastened to the first bolt 261 to be in close contact with the rotating plate 200, and a washer that prevents loosening of the first bolt 261 may be installed between the head part of the first bolt 261 and the rotating plate 200.

The connection device 1000 for a detachable backhoe includes a third support plate 600 installed on a side of the first, second, and third locking members 300, 400, and 500 toward the opposite side of the rotating plate 200; and a fourth support plate 700 installed on the opposite side of the first, second, and third locking members 300, 400, and 500 so as to be adjacent to the rotating plate 200.

Here, the handle member 510 is installed on the third and fourth support plates 600 and 700, and the third and fourth support plates 600 and 700 support the first, second, and third locking members 300, 400, 500 to rotate on the first, second, and third hinge parts220, 230, 240, respectively.

In addition, the fourth support plate 700 has a through hole through which the second holding part 250 passes.

A first rotation hole 350 which is rotatably fitted over the first hinge part 220 is formed on the outer surface of the first locking member 300.

Here, the first rotation hole 350 is formed through the front surface of the first locking member 300 so as to be located on the left side of the first fixing part 340 when viewed from the front.

A sixth through hole 221 is formed on the outer surface of the first hinge part 220through the first hinge part 220 and the rotating plate 200, and a seventh through hole 610 connected to the sixth through hole 221 is formed on the outer surface of the third support plate 600.

Here, the seventh through hole 610 is formed through the upper portion of the front surface of the third support plate 600 when viewed from the front.

An eighth through hole 710 through which the first hinge part 220 passes is formed on the outer surface of the fourth support plate 700.

Here, the eighth through hole 710 is formed through the upper portion of the front surface of the fourth support plate 700 when viewed from the front.

The connection device 1000 for a detachable backhoe includes a second bolt 800 sequentially penetrating the seventh through hole 610 and the sixth through hole 221; and a second nut 800a fastened to a portion of the second bolt 800 penetrating the rotating plate 200 so that the second bolt 800 is fixed to the sixth and seventh through holes 221 and 610.

Here, the head part of the second bolt 800 is in close contact with the third support plate 600, the second nut 800a is fastened to the second bolt 800 to be in close contact with the first hinge part 220, and a washer that prevents loosening of the second bolt 800 may be installed between the head part of the second bolt 800 and the third support plate 600.

A second rotation hole 450 which is rotatably fitted over the second hinge part 230 is formed on the outer surface of the second locking member 400.

Here, the second rotation hole 450 is formed through the front surface of the second locking member 400 so as to be positioned above the second fixing part 440 when viewed from the front.

A ninth through hole 231 is formed on the outer surface of the second hinge part 230through the second hinge part 230 and the rotating plate 200, and a tenth through hole 620 connected to the ninth through hole 231 is formed on the outer surface of the third support plate 600.

Here, the tenth through hole 620 is formed through the lower portion of the front surface of the third support plate 600 when viewed from the front.

An eleventh through hole 720 through which the second hinge part 230 passes is formed on the outer surface of the fourth support plate 700.

Here, the eleventh through hole 720 is formed through the lower portion of the front surface of the fourth support plate 700 when viewed from the front.

The connection device 1000 for a detachable backhoe includes a third bolt 810 sequentially penetrating the tenth through hole 620 and the ninth through hole 231; and a third nut 810a fastened to a portion of the third bolt 810 penetrating the rotating plate 200 so that the third bolt 810 is fixed to the ninth and tenth through holes 231 and 620.

Here, the head part of the third bolt 810 is in close contact with the third support plate 600, the third nut 810a is fastened to the third bolt 810 to be in close contact with the second hinge part 230, and a washer that prevents loosening of the third bolt 810 may be installed between the head part of the third bolt 810 and the third support plate 600.

A third rotation hole 540 which is rotatably fitted over the third hinge part 240 is formed on the outer surface of the third locking member 500, and a twelfth through hole 550 is formed around the third rotation hole 540.

Here, the third rotation hole 540 is formed through the front surface of the third locking member 500 so as to be positioned above the twelfth through hole 550 when viewed from the front.

A thirteenth through hole 241 is formed on the outer surface of the third hinge part 240through the third hinge part 240 and the rotating plate 200, and a fourteenth through hole 630 through which the third hinge part 240 passes is formed on the outer surface of the third support plate 600.

Here, the fourteenth through hole 630 is formed through a portion close to the center of the front surface of the third support plate 600 when viewed from the front.

A fifteenth through hole 730 through which the third hinge part 240 passes is formed on the outer surface of the fourth support plate 700.

Here, the fifteenth through hole 730is formed through a portion close to the center of the front surface of the fourth support plate 700 when viewed from the front.

The handle member 510 includes a handle 511 having a fitting part 511a formed on one side thereof, with the fitting part 511a being fitted into the twelfth through hole 550 to be movable forward and backward; a rotating rod 513 connected to the fitting part 511a by a connecting member 512, fitted rotatably into the thirteenth through hole 241, and having a sixteenth through hole 513a formed on a portion of the rotating rod 513 penetrating the rotating plate 200; a third spring 514 through which the rotating rod 513 penetrating the rotating plate 200 passes; two fifth support plates 515 respectively having seventeenth through holes 515athrough which the rotating rod 513 passes and located on opposite sides of the third spring 514, respectively, so as to support the third spring 514; and a third fixing pin 516 fitted into the sixteenth through hole 513a to prevent the fifth support plates 515 from being detached from the rotating rod 513.

Here, when the handle 511 rotates about the rotating rod 513, the fitting part 511a is held in the twelfth through hole 550, and the handle member 510 and the third locking member 500 rotate together. The handle member 510 is elastically supported by the third spring 514, and the handle 511 is formed as a “U”-shaped rod.

In addition, the fifth support plates 515 are configured as washers, and one of the two fifth support plates 515 is supported on the third hinge part 240.

The first fixing hole 270 is formed on the outer surface of rotating plate 200.

Here, the first fixing hole 270 is formed through the front surface of the rotating plate 200 so as to be adjacent to the third hinge part 240 when viewed from the front.

In addition, while the first and second locking members 300 and 400 are fixed to the third locking member 500 so as not to rotate further, the fitting part 511a of the handle member 510 is moved forward through the twelfth through hole 550 by elasticity of the third spring 514 and is fitted into the first fixing hole 270.

The handle member 510 includes a fitting rod 517 located on the opposite side of the fitting part 511a and connected to the rotating rod 513 by the connecting member 512, and an eighteenth through hole 360 is formed on the outer surface of the first locking member 300, and a second fixing hole 280 is formed on the outer surface of the rotating plate 200.

Here, the eighteenth through hole 360 is formed through a portion close to the center of the front surface of the first locking member 300 so as to be positioned above the first fixing part 340 when viewed from the front.

In addition, while the first and second locking members 300 and 400 are fixed to the third locking member 500 so as not to rotate further, the fitting rod 517 of the handle member 510 is moved through the eighteenth through hole 360by elasticity of the third spring 514and is fitted into the second fixing hole 280.

The operation of the connection device 1000 for a detachable backhoe according to the embodiment of the present disclosure will be described as follows.

As illustrated in FIGS. 1 to 34, with the fixing bracket 100 mounted on the tractor 1 and the rotating plate 200 mounted on the backhoe 2, the lower portion of the rotating plate 200 is inserted into the insertion space 130 of the fixing bracket 100, and the rotation recess 210 is fitted into the lower pin 150.

In addition, the handle 511 of the handle member 510 is pulled.

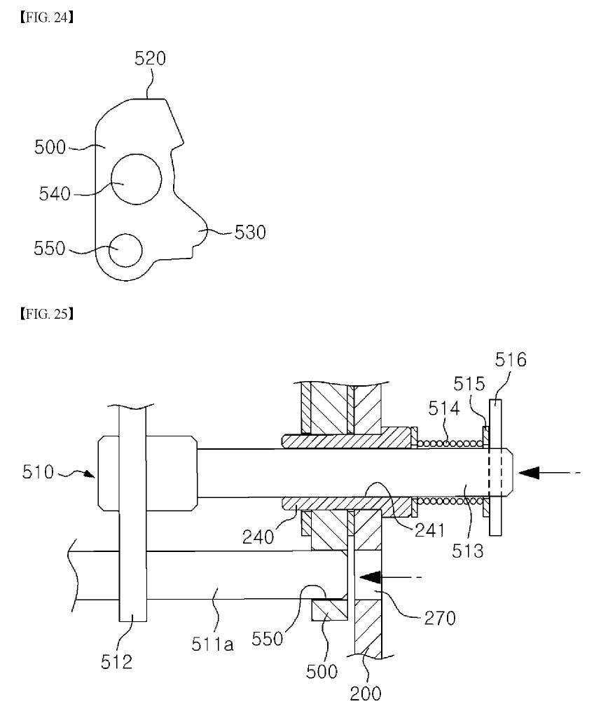

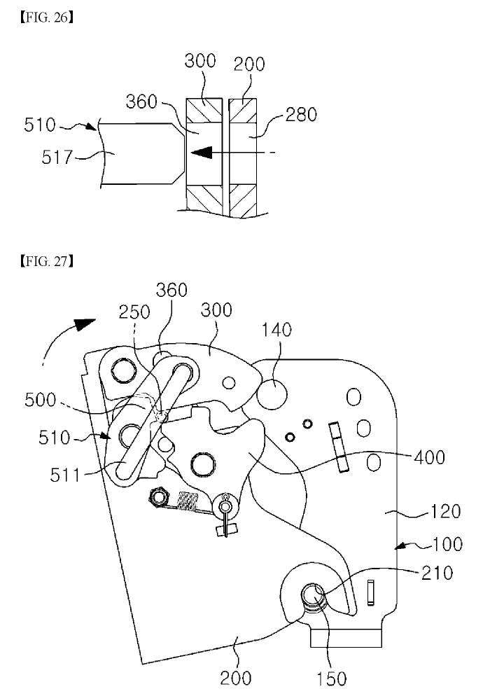

As illustrated in FIGS. 25 and 26, the fitting part 511a moves backward through the twelfth through hole 550 of the third locking member 500 to be removed from the first fixing hole 270 of the rotating plate 200, and the fitting rod 517 moves backward through the eighteenth through hole 360 of the first locking member 300 to be removed from the eighteenth through hole 360 and the second fixing hole 280 of the rotating plate 200.

In this case, the third spring 514 is compressed by the rotating rod 513 of the handle member 510 which moves backward through the thirteenth through hole 241 of the third hinge part 240.

For this reason, the first and third locking members 300 and 500 are in a state in which the first and third locking members 300 and 500 are capable of rotating freely.

In addition, when the handle member 510 is rotated clockwise when viewed from the front, the rotating rod 513 of the handle member 510 rotates about the thirteenth through hole 241 of the third hinge part 240.

In addition, the fitting part 511a of the handle member 510 is held in the twelfth through hole 550 of the third locking member 500, and the third locking member 500 rotates clockwise, together with the handle member 510, about the third hinge part 240 fitted into the third rotation hole 540 when viewed from the front.

In this case, the center of the fitting part 511a is misaligned with the center of the first fixing hole 270, and the center of the fitting rod 517 is misaligned with the center of the eighteenth through hole 360 and the center of the second fixing hole 280.

As illustrated in FIG. 27, the second holding part 250 of the rotating plate 200 is held on the third locking member 500 which is rotating, and the rotating plate 200 rotates clockwise about the lower pin 150 fitted into the rotation recess 210 when viewed from the front.

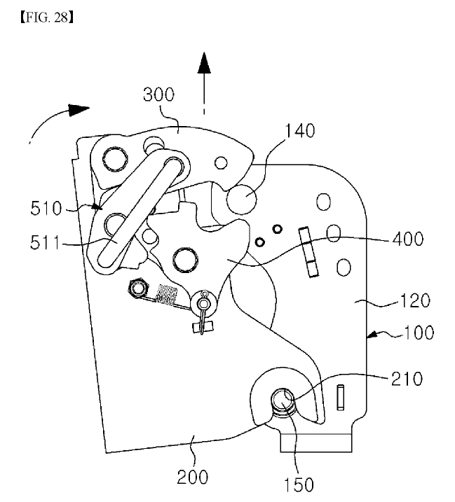

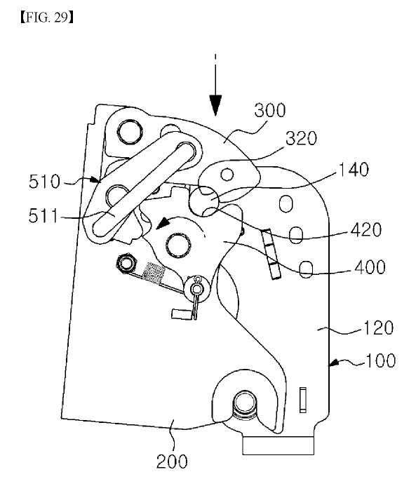

As illustrated in FIGS.28 and 29, the first locking member 300 rotates about the first hinge part 220 fitted into the first rotation hole 350 to be raised and lowered while being guided by the upper pin 140, and the second locking member 400 rotates counterclockwise about the second hinge part 230 fitted into the second rotation hole 450 when viewed from the front while being guided by the upper pin 140.

Thus, the first and second locking members 300 and 400 are elastically supported by the first and second springs 310 and 410, respectively, and move over the upper and lower portions of the upper pin 140, respectively, so that the upper pin 140 is fitted into the first and second holding recesses 320 and 420, so the first and second locking members 300 and 400 are fixed by being held by the upper pin 140.

In this case, the first and second springs 310 and 410 are extended.

For this reason, the upper pin 140 is tightly fitted into the first and second holding recesses 320 and 420 by the elasticity of the first and second springs 310 and 410 that return to original states thereof, and the first and second locking members 300 and 400 are fixed to the upper pin 140.

That is, the rotating plate 200 is locked so as not to be rotated in the fixing bracket 100 by the first and second locking members 300 and 400 which are fixed to the upper pin 140.

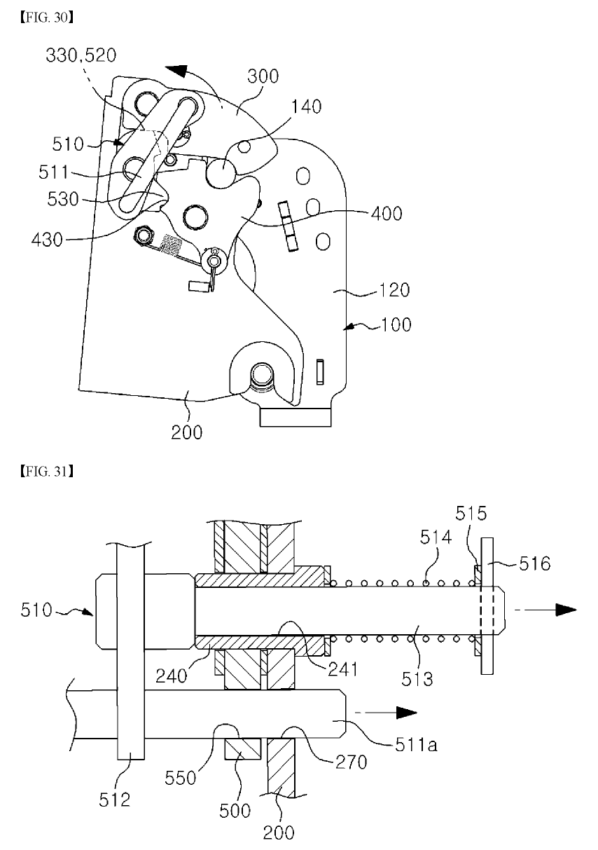

As illustrated in FIG. 30, when the handle member 510 is rotated counterclockwise when viewed from the front, the rotating rod 513 of the handle member 510 rotates about the thirteenth through hole 241 of the third hinge part 240.

In addition, the fitting part 511a of the handle member 510 is held in the twelfth through hole 550 of the third locking member 500, and the third locking member 500 rotates counterclockwise together with the handle member 510 about the third hinge part 240 fitted into the third rotation hole 540 when viewed from the front.

In this case, the first holding surface 330 of the first locking member 300 is in surface contact with the second holding surface 520 of the third locking member 500 to be held thereon by friction therebetween, and the third holding recess 430 of the second locking member 400 is fitted over and held on the first holding part 530 of the third locking member 500.

In this case, the center of the fitting part 511a is aligned with the center of the first fixing hole 270, and the center of the fitting rod 517 is aligned with the center of the eighteenth through hole 360 and the center of the second fixing hole 280.

For this reason, the first and second locking members 300 and 400 are prevented from rotating further by the third locking member 500 and are maintained in locked states thereof.

In addition, the pulling of handle 511 of the handle member 510 is released.

In this case, the rotating rod 513 of the handle member 510 is moved forward through the thirteenth through hole 241 of the third hinge part 240 by the elasticity of the third spring 514 which returns to an original state thereof.

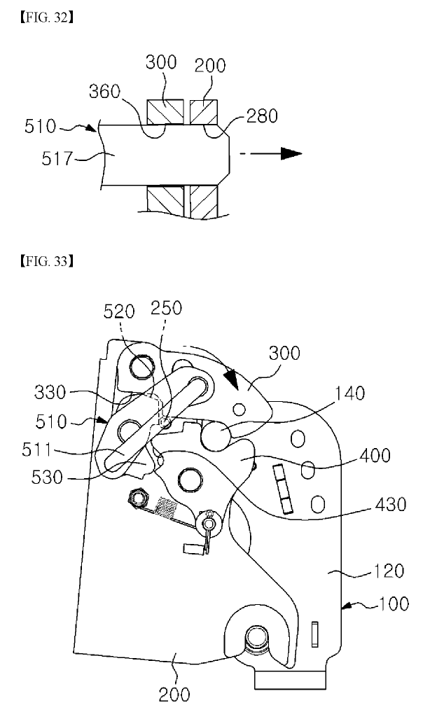

As illustrated in FIGS. 31 and 32, the fitting part 511a is moved forward through the twelfth through hole 550 of the third locking member 500 to be fitted into the first fixing hole 270 of the rotating plate 200, and the fitting rod 517 is moved forward through the eighteenth through hole 360of the first locking member 300 to be fitted into the eighteenth through hole 360 and the second fixing hole 280 of the rotating plate 200.

For this reason, the first and third locking members 300 and 500 are prevented from rotating further by the handle member 510 and are maintained in locked states thereof.

Thus, the backhoe 2 is attached to the tractor 1 by the connection device 1000 for a detachable backhoe according to the embodiment of the present disclosure.

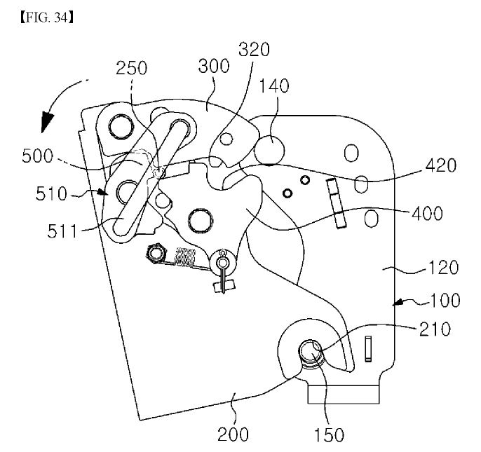

As illustrated in FIGS. 33 and 34, when the backhoe 2 is required to be detached, the handle 511 of the handle member 510 is pulled to detach the fitting part 511a from the first fixing hole 270 of the rotating plate 200 and to detach the fitting rod 517 from the eighteenth through hole 360 of the first locking member 300 and the second fixing hole 280 of the rotating plate 200.

In addition, the third locking member 500 is rotated clockwise when viewed from the front by the handle member 510 so that the third locking member 500 is held on the second holding part 250 of the rotating plate 200.

In this case, the first holding surface 330 of the first locking member 300 is released without being in surface contact with the second holding surface 520 of the third locking member 500, and the third holding recess 430 of the second locking member 400 is released as the first holding part 530 of the third locking member 500 is detached.

For this reason, the first and second locking members 300 and 400 are in a state in which the first and second locking members 300 and 400 are capable of rotating freely.

In addition, the second holding part 250 of the rotating plate 200 is pressed to the third locking member 500 by the handle member 510, and the rotation recess 210 of the rotating plate 200 is rotated counterclockwise about the lower pin 150 when viewed from the front.

In this case, the first and second locking members 300 and 400 are elastically supported by the first and second springs 310 and 410, respectively, to move over the upper and lower portions of the upper pin 140, respectively, and the upper pin 140 is released from the first and second holding recesses 320 and 420.

For this reason, the first and second locking members 300 and 400 are unlocked from the upper pin 140, and the rotating plate 200 mounted on the backhoe 2 is detached from the fixing bracket 100 mounted on the tractor 1.

Although the present disclosure has been described and illustrated with the specific preferred embodiment as examples, the present disclosure is not limited to the embodiment, and various changes and modifications may be made by those skilled in the art to which the present disclosure belongs within a scope that does not deviate from the spirit of the present disclosure.

What is claimed is:

1. A connection device for a detachable backhoe for attaching and detaching a backhoe (2) to and from a tractor (1), the connection device comprising:
a fixing bracket (100) mounted to the tractor (1) in such a manner that a first plate (110) and a second plate (120) are installed to face each other so that an insertion space (130) is formed between the first and second plates (110) and (120), first coupling holes (111) and (121) are formed to face each other in upper portions of the first and second plates (110) and (120), respectively, second coupling holes (112) and (122) are formed to face each other in lower portions of the first and second plates (110) and (120), respectively, an upper pin (140) is coupled to the first coupling holes (111) and (121), and a lower pin (150) is coupled to the second coupling holes (112) and (122);
a rotating plate (200) mounted to the backhoe (2) and having a rotation recess (210) formed on a lower portion thereof inserted into the insertion space (130) so that the rotation recess (210) is fitted over the lower pin (150) to rotate about the lower pin (150), with first, second, and third hinge parts (220), (230), and (240) being formed on an upper portion of the rotating plate (200) by protruding therefrom;
first and second locking members (300) and (400) installed on a first hinge part (220) and a second hinge part (230), respectively, so as to rotate in place toward the upper pin (140)while being elastically supported by first and second springs (310) and (410), respectively, wherein the first and second locking members (300) and (400) have first and second holding recesses (320) and (420), respectively, formed on surfaces thereof facing each other, and move over upper and lower portions of the upper pin (140), respectively, when the rotating plate (200) rotates and the upper pin (140) is fitted into the first and second holding recesses (320) and (420) so that the first and second locking members (300) and (400) are fixed by being held by the upper pin (140); and
a third locking member (500) that is installed on the third hinge part (240) to rotate in place together with a handle member (510) and fixes the first and second locking members (300) and (400) so that the first and second locking members (300) and (400) are prevented from being rotated further when the first and second locking members (300) and (400) are rotated by the handle member (510)with the first and second locking members (300) and (400) fixed to the upper pin (140).

2. The connection device of claim 1, wherein a first holding surface (330) is formed on a surface of the first locking member (300) adjacent to the third locking member (500), and
A second holding surface (520) is formed on a surface of the third locking member (500)adjacent to the first locking member (300), so that the second holding surface (520) is in contact with the first holding surface (330)when the third locking member (500) is rotated by the handle member (510) and fixes the first locking member (300)so that the first locking member (300) is prevented from being rotated further.

3. The connection device of claim 1, wherein a third holding recess (430) is formed on a surface of the second locking member (400) adjacent to the third locking member (500), and
a first holding part (530) is formed to protrude on a surface of the third locking member (500) adjacent to the second locking member (400), so that the first holding part (530) is fitted into and held in the third holding recess (430)when the third locking member (500) is rotated by the handle member (510) and fixes the second locking member (400) so that the second locking member (400) is prevented from being rotated further.

4. The connection device of claim 1, wherein a second holding part (250) positioned between the first, second, and third locking members (300), (400), and (500) is formed to protrude on an upper portion of the rotating plate (200),
the first and second locking members (300) and (400) are held by the second holding part (250) when the first and second locking members (300) and (400) are not fixed to the upper pin (140), and
the third locking member (500) is held by the second holding part (250) when the first and second locking members (300) and (400) are in a state in which the first and second locking members (300) and (400) are capable of being rotated when the third locking member (500) is rotated by the handle member (510).

5. The connection device of claim 1, wherein a first fixing part (340) having a first through hole (341) is formed to protrude on an outer surface of the first locking member (300) toward an opposite side of the rotating plate (200), and
a first hook (311) formed on one side of the first spring (310) is hooked to the first fixing part (340),
wherein the connection device further comprises:
a first support plate (342) which has a second through hole (342a) through which the first fixing part (340) passes and supports the first hook (311); and
a first fixing pin (343) which is fitted into the first through hole (341) and prevents the first support plate (342) from being detached from the first fixing part (340),
wherein a second fixing part (440) having a third through hole (441) is formed to protrude on an outer surface of the second locking member (400) toward the opposite side of the rotating plate (200), and
a first hook (411) formed on one side of the second spring (410) is hooked to the second fixing part (440),
wherein the connection device further comprises:
a second support plate (442) which has a fourth through hole (442a) through which the second fixing part (440) passes and supports the first hook (411); and
a second fixing pin (443) which is fitted into the third through hole (441) and prevents the second support plate (442) from being detached from the second fixing part (440),
wherein a fifth through hole (260) is formed on an outer surface of the rotating plate (200),
wherein the connection device further comprises:
a first bolt (261) which passes through the fifth through hole (260) so that second hooks (312) and (412) formed in hook shapes on the opposite sides of the first and second springs (310) and (410), respectively, are hooked to a portion of the first bolt (261) passing through the fifth through hole (260); and
three first nuts (262) which fix the first bolt (261) to the fifth through hole (260) and are fastened to the first bolt (261) so that the second hooks (312) and (412) are located between the three first nuts (262).

6. The connection device of claim 1, further comprising:
a third support plate (600) installed on one side of the first, second, and third locking members (300), (400), and (500) toward an opposite side of the rotating plate (200); and
a fourth support plate (700) installed on the opposite side of the first, second, and third locking members (300), (400), and (500) so as to be adjacent to the rotating plate (200),
wherein the handle member (510) is installed on the third and fourth support plates (600) and (700), and
the third and fourth support plates (600) and (700) support the first, second, and third locking members (300), (400), and (500) to rotate on the first, second, and third hinge parts (220), (230), (240), respectively.

7. The connection device of claim 6, wherein a first rotation hole (350) which is rotatably fitted over the first hinge part (220) is formed on an outer surface of the first locking member (300),
a sixth through hole (221) is formed on an outer surface of the first hinge part (220) through the first hinge part (220) and the rotating plate (200),
a seventh through hole (610) connected to the sixth through hole (221) is formed on an outer surface of the third support plate (600), and
an eighth through hole (710) through which the first hinge part (220) passes is formed on an outer surface of the fourth support plate (700),
wherein the connection device further comprises:
a second bolt (800) sequentially penetrating the seventh through hole (610) and the sixth through hole (221); and
a second nut (800a) fastened to a portion of the second bolt (800) penetrating the rotating plate (200) so that the second bolt (800) is fixed to the sixth and seventh through holes (221) and (610).

8. The connection device of claim 6, wherein a second rotation hole (450) which is rotatably fitted over the second hinge part (230) is formed on an outer surface of the second locking member (400),
a ninth through hole (231) is formed on an outer surface of the second hinge part (230) through the second hinge part (230) and the rotating plate (200),
a tenth through hole (620) connected to the ninth through hole (231) is formed on an outer surface of the third support plate (600), and
an eleventh through hole (720) through which the second hinge part (230) passes is formed on an outer surface of the fourth support plate (700),
wherein the connection device further comprises:
a third bolt (810) sequentially penetrating the tenth through hole (620) and the ninth through hole (231); and
a third nut (810a) fastened to a portion of the third bolt (810) penetrating the rotating plate (200) so that the third bolt (810) is fixed to the ninth and tenth through holes (231) and (620).

9. The connection device of claim 6, wherein a third rotation hole (540) which is rotatably fitted over the third hinge part (240) is formed on an outer surface of the third locking member (500), and a twelfth through hole (550) is formed around the third rotation hole (540),
a thirteenth through hole (241) is formed on an outer surface of the third hinge part (240) through the third hinge part (240) and the rotating plate (200),
a fourteenth through hole (630) through which the third hinge part (240) passes is formed on an outer surface of the third support plate (600), and
a fifteenth through hole (730) through which the third hinge part (240) passes is formed on an outer surface of the fourth support plate (700),
wherein the handle member (510) comprises:
a handle (511) having a fitting part (511a) formed on one side thereof, with the fitting part (511a) being fitted into the twelfth through hole (550) to be movable forward and backward;
a rotating rod (513) connected to the fitting part (511a) by a connecting member (512), fitted rotatably into the thirteenth through hole (241), and having a sixteenth through hole (513a) formed on a portion of the rotating rod (513) penetrating the rotating plate (200);
a third spring (514) through which the rotating rod (513) penetrating the rotating plate (200) passes;
two fifth support plates (515) respectively having seventeenth through holes(515a) through which the rotating rod (513) passes and located on opposite sides of the third spring (514), respectively, so as to support the third spring (514); and
a third fixing pin (516) fitted into the sixteenth through hole (513a) to prevent the fifth support plates (515) from being detached from the rotating rod (513).

10. The connection device of claim 9, wherein a first fixing hole (270) is formed on an outer surface of the rotating plate (200), and
while the first and second locking members (300) and (400) are fixed to the third locking member (500) so as not to rotate further, the fitting part (511a) of the handle member (510) is moved forward through the twelfth through hole (550) by elasticity of the third spring (514) and is fitted into the first fixing hole (270).

11. The connection device of claim 9, wherein the handle member (510) further comprises a fitting rod (517) located at an opposite side of the fitting part (511a) and connected to the rotating rod (513) by the connecting member (512),
an eighteenth through hole (360) is formed on an outer surface of the first locking member (300),
a second fixing hole (280) is formed on an outer surface of the rotating plate (200), and
while the first and second locking members (300) and (400) are fixed to the third locking member (500) so as not to rotate further, the fitting rod (517) of the handle member (510) is moved through the eighteenth through hole (360) by elasticity of the third spring (514) and is fitted into the second fixing hole (280).

12. The connection device of claim 1, wherein around the first coupling holes (111) and (121), first reinforcement parts (111a) and (121a) are formed on outer surfaces of the first and second plates (110) and (120), respectively, by protruding therefrom.

13. The connection device of claim 1, wherein around the second coupling holes (112) and (122), second reinforcement parts (112a) and (122a) are formed on outer surfaces of the first and second plates (110) and (120), respectively, by protruding therefrom.

14. The connection device of claim 1, wherein around the rotation recess (210), a third reinforcement part (211) is formed on an outer surface of the rotating plate (200) by protruding therefrom.
